(19) United States
(12) Patent Application Publication
(10) Pub. No.: US 2006/0088133 A1
(43) Pub. Date: Apr. 27, 2006

(54) Time-frequency correlation-based synchronization for coherent OFDM receiver

(75) Inventors: Ching-Yung Chen, Hsinchu (TW); Yi-Ting Wang, Hsinchu (TW); Yung-Hua Hung, Hsinchu (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: Industrial Technology Research Institute

(21) Appl. No.: 11/153,105

(22) Filed: Jun. 15, 2005

Related U.S. Application Data
(60) Provisional application No. 60/620,725, filed on Oct. 22, 2004.

(51) Int. Cl. H04L 27/06

(52) U.S. Cl. 375/343

(57) ABSTRACT

There is provided an apparatus for synchronizing pilots contained in symbols received by a receiver in a multicarrier transmission system and a method thereof. Time-frequency correlation-based scheme, with exploitation of time-frequency correlation characteristics of the pilots, is used for identifying the positions of the pilots in time and frequency dimensions consisting of received symbols. The apparatus includes a pilot compensator and a signal selector for determining at least one correlation set, a correlator for generating one correlation set result for each of the correlation set, and a judgment unit for determining positions of the pilots in response to the correlation set result.

### CROSS-REFERENCE TO RELATED APPLICATIONS

This application claims the benefit of U.S. Provisional Application No. 60/620,725, filed on Oct. 22, 2004, which is herein incorporated by reference in its entirety.

### BACKGROUND OF THE INVENTION

The present invention generally relates to digital broadcasting systems. More particular, the present invention relates to time-frequency correlation-based synchronization for coherent Orthogonal Frequency Division Multiplexing (OFDM) receivers in a multi-carrier digital broadcasting system, such as Digital Video Broadcasting-Terrestrial (DVB-T), Digital Video Broadcasting-Handheld (DVB-H) and Integrated Service Digital Broadcasting-Terrestrial (ISDB-T) system.

OFDM transmission technique, being one kind of the multi-carrier modulation schemes, has been widely applied for modem high-data-rate digital communications and broadcasting due to its extreme efficacy on dealing with the multipath propagation effects. The OFDM technique has been adopted by several broadcasting systems such as Digital Audio Broadcasting (DAB), DVB-T, DVB-H and ISDB-T, and, moreover, by local area networks such as the HiperLAN/2 and IEEE 802.11a/g/n. Specifically, the (inverse) fast Fourier transform (FFT) technique is employed in an OFDM transmission system for efficiently implementing multi-carrier modulation and demodulation.

For coherent OFDM-based systems such as the DVB-T/H and ISDB-T systems, certain scattered pilots (known as SPs hereinafter) regularly posited in time- and frequency-dimensions are transmitted together with information data at OFDM transmitters' end and used for channel estimation and equalization at OFDM receivers' end. Referring to FIG. 1, a diagram illustrating positions of SPs defined in DVB-T/H systems with respect to the time-frequency dimension in the frequency domain is provided. The positions of SPs in DVB-T/H systems can be expressed as follows:

For the OFDM symbol of index l (ranging from 0 to 67), carriers for which index k belongs to the subset {k=Kₘᵢₙ+3×(l mod 4)+12p|p integer, p≧0, kε[Kₘᵢₙ, Kₘₐₓ]} are SPs, where p is an integer that takes all possible values greater than or equal to zero, provided that the resulting value for k does not exceed the valid range [Kₘᵢₙ, Kₘₐₓ]. Kₘₐₓ is 1704 for the 2K mode, 3408 for the 4K mode and 6816 for the 8K mode as defined by DVB-T/H standards.

The positions of the SPs should be detected and identified by means of a synchronization sequence (or synchronization procedure) at a coherent OFDM receiver. Assume that the received Radio Frequency (RF) signal is first down converted to the baseband using a tuner and a carrier recovery loop. A typical DVB-T/H baseband synchronization sequence 20 is illustrated in FIG. 2. After the start-up, pre-FFT synchronization is performed in step 21 in which all metrics are derived in time-domain from guard interval correlation. The baseband signal is then transformed to the frequency-domain through FFT. Subsequently, post-FFT synchronization is performed in frequency-domain in step 22 based on correlating the Continual Pilots (CP) of two consecutive OFDM symbols. Specifically, the pre-FFT and post-FFT synchronization blocks perform the sampling clock, OFDM symbol timing and carrier frequency synchronization.

After sampling clock, OFDM symbol timing and carrier frequency synchronization have been achieved via the pre-FFT and post-FFT synchronization, the positions of the SPs within an OFDM symbol has to be determined before channel estimation can be performed in step 24. As shown in FIG. 2, Transmission Parameters Signaling (TPS) decoding procedure is utilized in step 23 which determines the positions of the SPs by detecting a frame boundary as the scattered pilot positions (known as SPPs hereinafter) are directly related to the OFDM frame. The detection of the frame boundary is so-called “frame synchronization.” Typically, the frame synchronization takes a variable synchronization time of 68˜136 OFDM symbols, 68˜136 T_{OFDM}, which is around 50%˜70% of the overall synchronization time associated with the total synchronization procedure 20. Thus, the conventional frame synchronization is considerably time-consuming. In particular, for DVB-H time-slicing purposes of burst-mode transmission, the receiver may prepare for the required frame synchronization time even longer than the data burst duration of interest. Therefore, the conventional frame boundary detection based SPPs identification (or SPs synchronization) scheme is especially inefficient in the sense of power reduction for receiving the time-sliced DVB-H signals.

### BRIEF SUMMARY OF THE INVENTION

The present invention is directed to a time-frequency correlation-based synchronization for coherent Orthogonal Frequency Division Multiplexing (OFDM) receivers in a multi-carrier digital broadcasting system that obviate one or more problems resulting from the limitations and disadvantages of the prior art.

In accordance with an embodiment of the present invention, there is provided a method of synchronizing pilots contained in OFDM symbols received by a receiver in a multicarrier transmission system. The pilots have predetermined known values posited among data carriers in time and frequency dimensions and a predetermined position pattern in said time and frequency dimensions. The predetermined position pattern further comprises of a finite number of sub-position patterns, and each sub-position pattern corresponds to positions of pilots contained in one of the OFDM symbols. The method involves determining at least one correlation set in said time and frequency dimensions between at least two of said received symbols. A correlation set result is generated in response to each said correlation set before determining positions of said pilots in said time and frequency dimensions in response to said correlation set result. Then, the positions of said pilots of current symbols are determined either as said sub-position pattern corresponding to correlation set with maximum correlation set result or as said sub-position pattern corresponding to correlation set with correlation set result being greater than a predetermined threshold value.

In accordance with another embodiment of the present invention, there is provided an apparatus for synchronizing pilots contained in symbols received by a receiver in a multicarrier transmission system. As described above, the pilots have predetermined known values posited among data carriers in time and frequency dimensions and a predetermined position pattern in said time and frequency dimensions. The predetermined position pattern further comprises of a finite number of sub-position patterns, and each sub-position pattern corresponds to positions of pilots contained in one of the OFDM symbols. The apparatus comprises a pilots compensator and a signal selector for determining said at least one correlation set, a correlator for generating one correlation set result for each said correlation set, and a judgment unit for determining positions of said pilots in response to said correlation set result. The judgment unit also comprises either a comparator or a threshold detector. The positions of said pilots of current symbols are determined either as said sub-position pattern corresponding to correlation set with maximum correlation set result or as said sub-position pattern corresponding to correlation set with correlation set result being greater than a predetermined threshold value.

As compared with the conventional time correlation-based scheme, the time-frequency correlation-based scheme according to the present invention require only two adjacent OFDM symbols in order to compute the correlation set results and then determine the maximum thereof to be associated with the judgment result indicating the correct scattered pilot positions of the current symbol. The time-frequency correlation-based scheme of the present invention hence benefits not only the ability of fast synchronization speed but also the robustness against Doppler effects due to less stringent requirement on the channel coherence time. In addition, the time-frequency correlation-based scheme of the present invention is less sensitive to sampling clock frequency offset effects than the conventional time correlation-based scheme. Also, as compared with the conventional power-based scheme, the time-frequency correlation-based scheme of the present invention exhibits robustness against noise effects due to the correlation gain at the cost of slightly longer synchronization time.

Furthermore, another advantage of the present invention over both time correlation-based and power-based schemes is that the time-frequency correlation-based scheme is free from the correlation-interference caused by continual pilots defined in coherent OFDM-based systems where the continual pilots are continuously located at the same subset of sub-carriers over all OFDM symbols.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a diagram illustrating positions of SPs in DVB-T/H systems;

FIG. 2 is a diagram illustrating a typical DVB-T/H synchronization sequence (or synchronization procedure);

FIG. 3 is a diagram illustrating a prior art time correlation-based SPPs identification scheme;

FIG. 4 is a diagram illustrating a prior art power-based SPPs identification scheme;

FIG. 5 is a diagram illustrating positions of SPs for explaining one preferred embodiment in accordance with a time-frequency correlation-based scheme of the present invention;

FIG. 6 is a block diagram of one example to implement the preferred embodiment of FIG. 5;

FIGS. 7A and 7B are diagrams illustrating the minimum protection ratio (MPR) associated with the time-frequency correlation-based scheme of the present invention, the conventional time correlation-based and power-based schemes upon simulation results;

FIG. 8 is a diagram illustrating positions of SPs for explaining another preferred embodiment in accordance with a time-frequency correlation-based scheme of the present invention; and

FIG. 9 is a diagram illustrating an application of the present invention in the synchronization procedure of DVB-T/H receivers.

### DETAILED DESCRIPTION OF THE INVENTION

According to the present invention, a time-frequency correlation-based scheme that exploits time-frequency correlation characteristics of the SPs is provided for robust SP synchronization without TPS synchronization. It is to be understood that the present invention may be implemented in various forms of hardware, software, firmware, special purpose processors, or a combination thereof.

It is to be further understood that, because some of the constituent system components and method steps depicted in the accompanying figures are preferably implemented in a combination of hardware and software, the actual connections between the system components (or the process steps) may differ depending upon the manner in which the present invention is programmed. Given the teachings herein, one of ordinary skill in the related art will be able to contemplate these and similar implementations or configurations of the present invention.

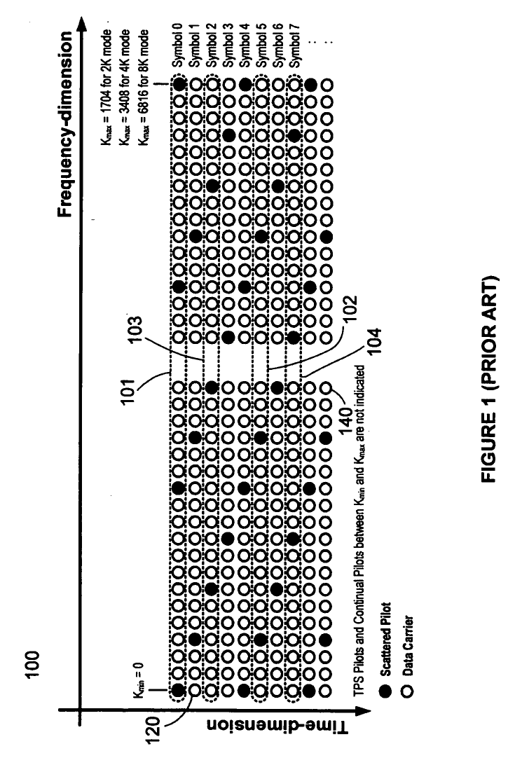

For ease of presenting the concept and the methods of the present invention, let us consider the SPPs identification for the DVB-T/H systems as an example. It is to be understood that the concept and the methods of the present invention can be applied to any coherent OFDM-based systems. Referring to FIG. 1, SPPs are designated by solid circles which appear as regular position pattern. The position pattern associated with the SPPs further comprises of four sub-position patterns: 101, 102, 103 and 104 in FIG. 1, wherein each sub-position pattern in the time-dimension will repeat once for every four OFDM symbols. The four sub-position patterns 101, 102, 103 and 104 are denoted as sub-position patterns 1, 2, 3, and 4, respectively. Moreover, the SPPs shift three subcarriers in view of the frequency-dimension between two adjacent OFDM symbols, and eleven data carriers are arranged between two scattered pilots in each OFDM symbol. For ease of presentation, R_{l,k} is defined as the received baseband signal on the kth sub-carrier of the lth OFDM symbol. For example, the signal in the position 120 is denoted by R_{1,0} and the signal in the position 140 is denoted by R_{9,18}.

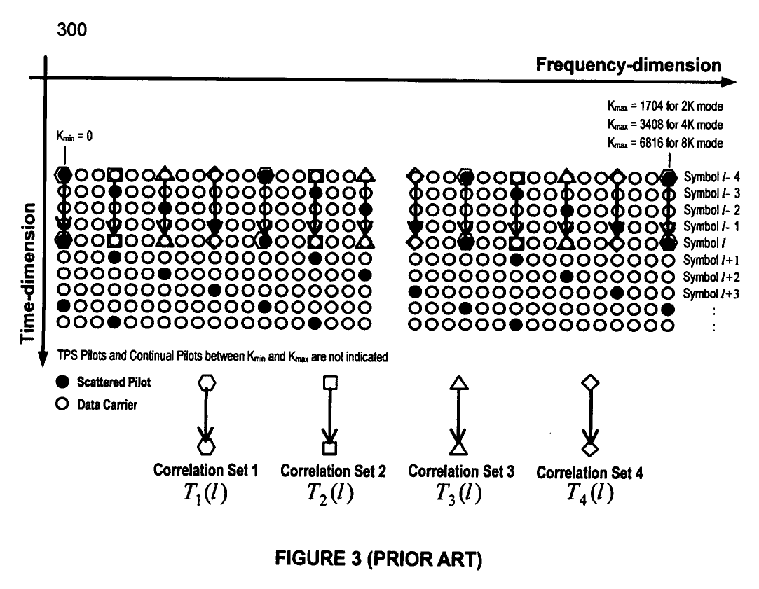

FIG. 3 is a diagram illustrating a prior art time correlation-based SPPs identification scheme as disclosed in L. Schwoerer and J. Vesma, “Fast Scattered Pilot Synchronization for DVB-T and DVB-H,” Proc. 8^{th} International OFDM Workshop, Hamburg, Germany, Sep. 24-25, 2003. As can be observed from FIG. 3, four sets of correlation are performed for the four possible SPPs along the time-dimension and both the current and the last fourth OFDM symbols have to be accessed for each correlation set. The four correlation sets Tᵢ(l), iε{1, 2, 3, 4} are given as follows:

$${T}_{i} ( l ) = \vert {\sum }_{p = 0}^{{P}_{max}} {R}_{l , 12 p + 3 ( i - 1 )} \cdot {R}_{l - 4 , 12 p + 3 ( i - 1 )}^{*} \vert$$

Theoretically, the SPs are correlated while the data symbols are uncorrelated. Thus, a correlation magnitude maximum is found for the position pattern of the current SPP as

$${SPP}_{T} ( l ) = arg {max}_{i} ( {T}_{i} ( l ) ) ; i ∈ \{ 1 , 2 , 3 , 4 \} .$$

This approach exploits features of the SPs themselves instead of the TPS such that the time needed for SPPs identification is reduced to 5 T_{OFDM}. However, the time correlation-based SPPs identification scheme is quite sensitive to Doppler effects and sampling clock frequency offset (ScFO) effects.

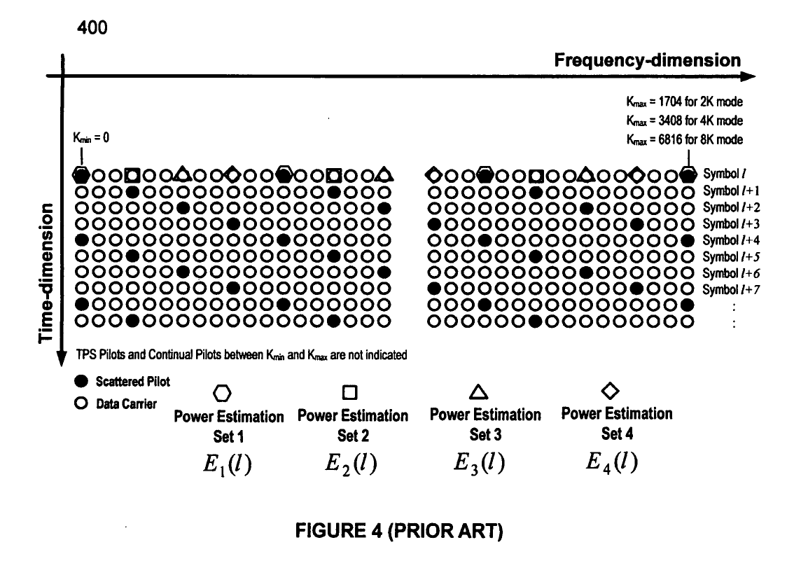

FIG. 4 is a diagram illustrating another prior art power-based SPPs identification scheme as disclosed in L. Schwoerer, “Fast Pilot Synchronization Schemes for DVB-H,” Proc. Wireless and Optical Communications, Banff, Canada, Jul. 8-10, 2004, pp. 420-424. As can be observed from FIG. 4, four sets of power estimators are performed for the four possible SPPs and only the current OFDM symbol needs to be accessed for each set of power estimators. The four power estimation sets Eᵢ(l), iε{1, 2, 3, 4} are given as follows:

$${E}_{i} ( l ) = {\sum }_{p = 0}^{{P}_{max}} {\vert {R}_{l , 12 p + 3 ( i - 1 )} \vert}^{2}$$

Definitely, the power of SPs is higher than the data symbols. Thus, a power maximum is found for the position pattern of the current SPP as

$${SPP}_{E} ( l ) = arg {max}_{i} ( {E}_{i} ( l ) ) ; i ∈ \{ 1 , 2 , 3 , 4 \} .$$

This approach exploits features of the SPs themselves instead of the TPS such that the time needed for SPPs identification is reduced to 1 T_{OFDM}. However, the power-based SPPs identification scheme is quite sensitive to noise effects and ill-conditioned channel effects (e.g., echo in single-frequency networks (SFN)).

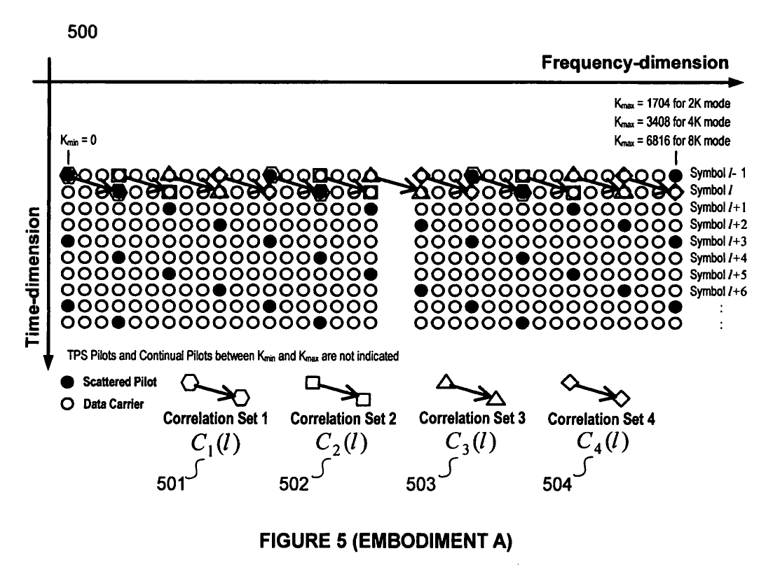

Based upon the characteristics of the SPPs above, the present invention sets forth a time-frequency correlation-based scheme for the purpose of fast and robust SPs synchronization for OFDM receivers. Referring to FIG. 5, a diagram illustrating the SPPs for explaining the time-frequency correlation-based scheme in accordance with one preferred embodiment of the present invention is depicted schematically. As shown in FIG. 5, four correlation sets C₁(l), C₂(l), C₃(l), C₄(l) (i.e., 501, 502, 503 and 504) in view of two adjacent OFDM symbols are used for SPPs identification. The four correlation sets Cᵢ(l), iε{1, 2, 3, 4} are given as follows:

$${C}_{1} ( l ) = \vert {\sum }_{p = 0}^{{P}_{max}} ( {R}_{l , 12 p + 3} \cdot {P}_{12 p + 3} ) \cdot ( {R}_{l - 1 , 12 p}^{*} \cdot {P}_{12 p}^{*} ) \vert$$

$${C}_{2} ( l ) = \vert {\sum }_{p = 0}^{{P}_{max}} ( {R}_{l , 12 p + 6} \cdot {P}_{12 p + 6} ) \cdot ( {R}_{l - 1 , 12 p + 3}^{*} \cdot {P}_{12 p + 3}^{*} ) \vert$$

$${C}_{3} ( l ) = \vert {\sum }_{p = 0}^{{P}_{max}} ( {R}_{l , 12 p + 9} \cdot {P}_{12 p + 9} ) \cdot ( {R}_{l - 1 , 12 p + 6}^{*} \cdot {P}_{12 p + 6}^{*} ) \vert$$

$${C}_{4} ( l ) = \vert {\sum }_{p = 0}^{{P}_{max}} ( {R}_{l , 12 p + 12} \cdot {P}_{12 p + 12} ) \cdot ( {R}_{l - 1 , 12 p + 9}^{*} \cdot {P}_{12 p + 9}^{*} ) \vert$$

where Pₖ=±1 with kεS_{SP}={0, 3, 6, 9, . . . , Kₘₐₓ} (a set of all subcarrier indices associated with all SPPs) is the (sign of the) value of the SP on kth sub-carrier defined by the DVB-T/H standard and (pₘₐₓ, Kₘₐₓ)=(141, 1704), (283, 3408) and (567, 6816) for 2K, 4K and 8K modes respectively. Note that Pₖ's required by computing the correlation Cᵢ(l) are used for SPs compensation such that (R_{l,k}·Pₖ) and (R_{l-1,k-3}·Pₖ₋₃) could be positively correlated if R_{l,k} carries a SP. Then, a clear distinct correlation magnitude maximum should be found for the position pattern of the current SPP as

$$SPP ( l ) = arg {max}_{i} ( {C}_{i} ( l ) ) ; i ∈ \{ 1 , 2 , 3 , 4 \} .$$

As an example, suppose that Symbol 0 and Symbol 1 shown in FIG. 1 are used to generate four correlations C₁(1), C₂(1), C₃(1), C₄(1), where Symbol 1 is the current OFDM symbol, i.e., l=1. The correlation C₁(1) is then greater than the other three correlations C₂(1), C₃(1), C₄(1). Moreover, suppose that Symbol 1 and Symbol 2 shown in FIG. 1 are utilized to generate four correlations C₁(2), C₂(2), C₃(2), C₄(2), where Symbol 2 is the current OFDM symbol, i.e., l=2. The correlation C₂(2) is then greater than the other three correlations C₁(2), C₃(2), C₄(2). Furthermore, suppose that Symbol 2 and Symbol 3 shown in FIG. 1 are utilized to generate four correlations C₁(3), C₂(3), C₃(3), C₄(3), where Symbol 3 is the current OFDM symbol, i.e., l=3. The correlation C₃(3) is then greater than the other three correlations C₁(3), C₂(3), C₄(3). In addition, suppose that Symbol 3 and Symbol 4 shown in FIG. 1 are utilized to generate four correlations C₁(4), C₂(4), C₃(4), C₄(4), where Symbol 4 is the current OFDM symbol, i.e., l=4. The correlation C₄(4) is then greater than the other three correlations C₁(4), C₂(4), C₃(4).

It is to be noted that, instead of accumulating all available (pₘₐₓ+1) complex values of (R_{l,12p+3i}·P₁₂ₚ₊₃ᵢ)·(R_{l-1,12p+3(i-1)}*·P₁₂ₚ₊₃₍ᵢ₋₁₎) for Cᵢ(l), iε{1, 2, 3, 4}, accumulation of only partial set of complex values of (R_{l,12p+3i}·P₁₂ₚ₊₃ᵢ)·(R_{l-1,12p+3(i-1)}*·P₁₂ₚ₊₃₍ᵢ₋₁₎) may suffice for robust SPPs identification. Therefore, the four correlation sets Cᵢ(l), iε{1, 2, 3, 4} can be generalized as

$${C}_{i} ( l ) = \vert {\sum }_{p ∈ Z} ( {R}_{l , 12 p + 3 i} \cdot {P}_{12 p + 3 i} ) \cdot ( {R}_{l - 1 , 12 p + 3 ( i - l )}^{*} \cdot {P}_{12 p + 3 ( i - 1 )}^{*} ) \vert$$

where Z⊂{0, 1, 2, . . . , pₘₐₓ}.

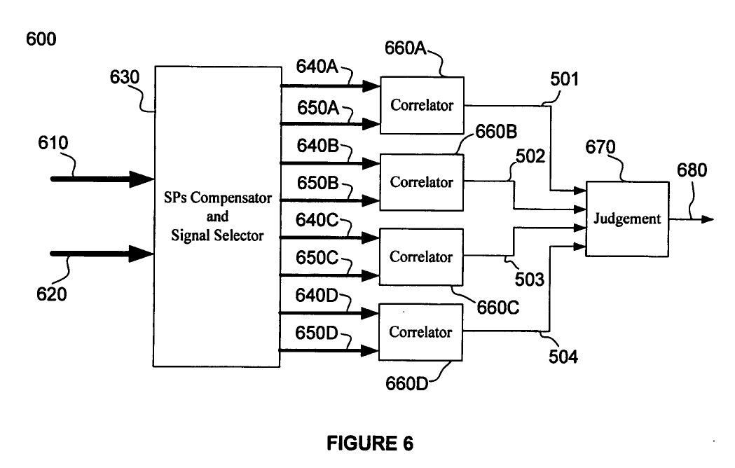

Referring to FIG. 6, a block diagram of one example to implement the time-frequency correlation-based scheme of the present invention as depicted in FIG. 5 is provided. As shown in FIG. 6, the time-frequency correlation-based scheme of the present invention basically comprises a SPs compensator and signal selector 630, four correlators 660A, 660B, 660C and 660D, and a judgement block 670. Signals 610 and 620 applied to the SPs compensator and signal selector 630 are the received baseband signal R_{l,k} by an OFDM receiver and Pₖ where kεS_{SP}={0, 3, 6, 9, . . . , Kₘₐₓ}. The SPs compensator and signal selector 630 are employed to obtain sub-signals 640A, 640B, 640C, 640D, 650A, 650B, 650C, and 650D, which are associated to (R_{l,12p+3}·P₁₂ₚ₊₃), (R_{l,12p+6}·P₁₂ₚ₊₆), (R_{l,12p+9}·P₁₂ₚ₊₉), (R_{l,12p+12}·P₁₂ₚ₊₁₂), (R_{l-1,12p}·P₁₂ₚ), (R_{l-1,12p+3}·P₁₂ₚ₊₃), (R_{l-1,12p+6}·P₁₂ₚ₊₆) and (R_{l-1,12p+9}·P₁₂ₚ₊₉), respectively, where pεZ⊂{0, 1, 2, . . . , pₘₐₓ}. Preferably, the SPs compensator and signal selector 630 includes a buffer to receive the signals 610 for storing the signals of the previous OFDM symbol l−1. Sub-signals 640A and 650A are applied to the correlator 660A, sub-signals 640B and 650B are applied to the correlator 660B, sub-signals 640C and 650C are applied to the correlator 660C, and sub-signals 640D and 650D are applied to the correlator 660D. The correlators 660A, 660B, 660C and 660D are employed to compute four correlation set results 501, 502, 503 and 504, which are associated to the correlation sets C₁(l), C₂(l), C₃(l) and C₄(l) as depicted in FIG. 5, respectively. Preferably, the correlator 660A includes a complex conjugate function to generate the conjugate part of a signal, a complex multiplier and an accumulator, while correlators 660B, 660C and 660D can be implemented the same. Subsequently, the four correlation set results 501, 502, 503 and 504 are all supplied to a judgment block 670 to determine the maximum thereof and generate a judgment result 680 as SPP(l) indicating the position pattern exhibited by the SPs in the current lth OFDM symbol accordingly. Preferably, the judgment unit 680 includes a peak detector or a comparator so as to determine the maximum of correlation set results 501, 502, 503 and 504. It is to be understood that, because some of the sub-signals 640A, 640B, 640C, 640D, 650A, 650B, 650C, and 650D appear in different time, one of ordinary skill in the related art such as time-sharing based hardware design will be able to obtain the four correlation set results 501, 502, 503 and 504 with only one correlator 660A.

It is to be noted that, in virtue of the fact that (R_{l,k}·Pₖ) and (R_{l-1,k-3}·Pₖ₋₃) could be positively correlated if R_{l,k} carries a SP, the four correlation sets Cᵢ(l), iε{1, 2, 3, 4} can be further simplified as

$${C}_{i} ( l ) = \vert {\sum }_{p ∈ Z} Re \{ ( {R}_{l , 12 p + 3 i} \cdot {P}_{12 p + 3 i} ) \cdot ( {R}_{l - 1 , 12 p + 3 ( i - l )}^{*} \cdot {P}_{12 p + 3 ( i - 1 )}^{*} ) \} \vert$$

where Z⊂{0, 1, 2, . . . , pₘₐₓ}. Therefore, instead of obtaining the result of (R_{l,12p+3i}·P₁₂ₚ₊₃ᵢ)·(R_{l-1,12p+3(i-1)}*·P₁₂ₚ₊₃₍ᵢ₋₁₎*) by a complex multiplier, only two real multipliers and one adder suffice for computing

$$Re \{ ( {R}_{l , 12 p + 3 i} \cdot {P}_{12 p + 3 i} ) \cdot ( {R}_{l - 1 , 12 p + 3 ( i - l )}^{*} \cdot {P}_{12 p + 3 ( i - 1 )}^{*} ) \} = Re \{ {R}_{l , 12 p + 3 i} \cdot {P}_{12 p + 3 i} \} \cdot Re \{ {R}_{l - 1 , 12 p + 3 ( i - l )} \cdot {P}_{12 p + 3 ( i - 1 )} \} + Im \{ {R}_{l , 12 p + 3 i} \cdot {P}_{12 p + 3 i} \} \cdot Im \{ {R}_{l - 1 , 12 p + 3 ( i - l )} \cdot {P}_{12 p + 3 ( i - 1 )} \}$$

for Cᵢ(l), iε{1, 2, 3, 4}.

As compared with the conventional time correlation-based scheme of the required synchronization time 5 T_{OFDM}, the time-frequency correlation-based scheme according to the present invention require only two adjacent OFDM symbols in order to compute the correlation set results C₁(l), C₂(l), C₃(l), C₄(l) and then determine the maximum thereof to be associated with the judgment result 680 indicating the correct SPPs of the current symbol. The time-frequency correlation-based scheme of the present invention hence benefits not only the ability of fast synchronization speed but also the robustness against Doppler effects due to less stringent requirement on the channel coherence time. In addition, the time-frequency correlation-based scheme of the present invention is less sensitive to ScFO effects than the conventional time correlation-based scheme. On the other hand, as compared with the conventional power-based scheme of the required synchronization time T_{OFDM}, the time-frequency correlation-based scheme of the present invention exhibits robustness against noise effects due to the correlation gain at the cost of slightly longer synchronization time 2 T_{OFDM}. Furthermore, another advantage of the present invention over both time correlation-based and power-based schemes is that the time-frequency correlation-based scheme is free from the correlation-interference caused by CP defined in DVB-TIH where the CP are continuously located at the same subset S_{CP} of subcarriers over all OFDM symbols with S_{CP}⊂S_{SP}.

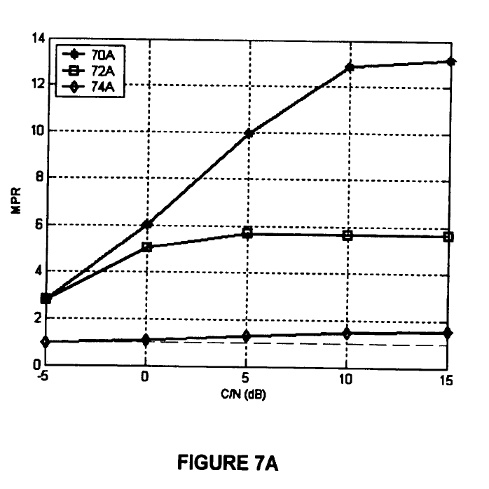

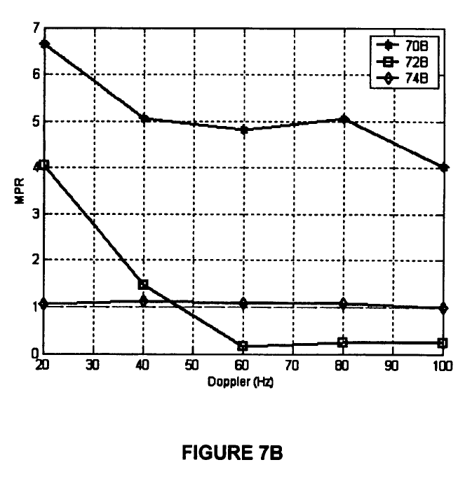

Some of the simulation results (for 8 k mode in DVB-T/H with a guard interval of ¼ useful symbol length) are shown in FIGS. 7A and 7B for supporting the efficacy and robustness of the time-frequency correlation-based scheme in accordance with the present invention. FIGS. 7A and 7B plot the minimum protection ratio (MPR), a performance index used by L. Schwoerer, “Fast Pilot Synchronization Schemes for DVB-H,” Proc. Wireless and Optical Communications, Banff, Canada, Jul. 8-10, 2004, pp. 420-424, associated with the time-frequency correlation-based scheme of the present invention, the conventional time correlation-based and power-based schemes over 1000 independent runs for static AWGN channel model with various carrier-to-noise ratio (C/N) and typical urban channel model with various Doppler frequencies (with C/N=5 dB), respectively. The MPR for the time-frequency correlation-based scheme of the present invention is defined as

$$MPR = {min}_{n} ( PR ( n ) ) ; n ∈ \{ 1 , 2 , … , 1000 \}$$

where PR(n) is the protection ratio associated with the nth independent run and is defined as

$$PR ( n ) = {min}_{i} ( \frac{{C}_{{i}_{true}}^{( n )} ( l )}{{C}_{i}^{( n )} ( l )} ) ; i ∈ \{ 1 , 2 , 3 , 4 \} and i \neq {i}_{true}$$

in which iₜᵣᵤₑε{1, 2, 3, 4} is the position pattern index corresponding to the true SPPs associated with the lth OFDM symbol. The MPRs for the conventional time correlation-based and power-based schemes are defined in a similar way with Cᵢ⁽ⁿ⁾(l) replaced by Tᵢ⁽ⁿ⁾(l) and Eᵢ⁽ⁿ⁾(l), respectively. It is noted that the higher the MPR value the more robust the performance of the SPPs identification scheme, where MPR<1 implies at least one erroneous detection of the SPPs exists over the 1000 independent runs.

In FIGS. 7A and 7B, curves 70A and 70B are associated with the time-frequency correlation-based scheme of the present invention, wherein curves 72A and 72B correspond to the conventional time correlation-based scheme and curves 74A and 74b correspond to the conventional power-based scheme.

As shown in FIG. 7A, both the time-frequency correlation-based scheme of the present invention and the conventional time correlation-based scheme are uniformly more robust against noise effects than the conventional power-based scheme due to the correlation gain. The time-frequency correlation-based scheme of the present invention further outperforms the conventional time correlation-based scheme under higher C/N because the latter suffers from the correlation-interference due to CP that dominates the performance for low noise condition. As shown in FIG. 7B, the conventional power-based scheme is as expected insensitive to Doppler effects and the time-frequency correlation-based scheme of the present invention is more robust against Doppler effects than the conventional time correlation-based scheme whose performance is significantly degraded for Doppler frequency larger than 60 Hz because the latter requires longer coherence time. In summary, the time-frequency correlation-based scheme of the present invention outperforms the conventional time correlation-based and power-based schemes in view of robustness against both Doppler and noise effects.

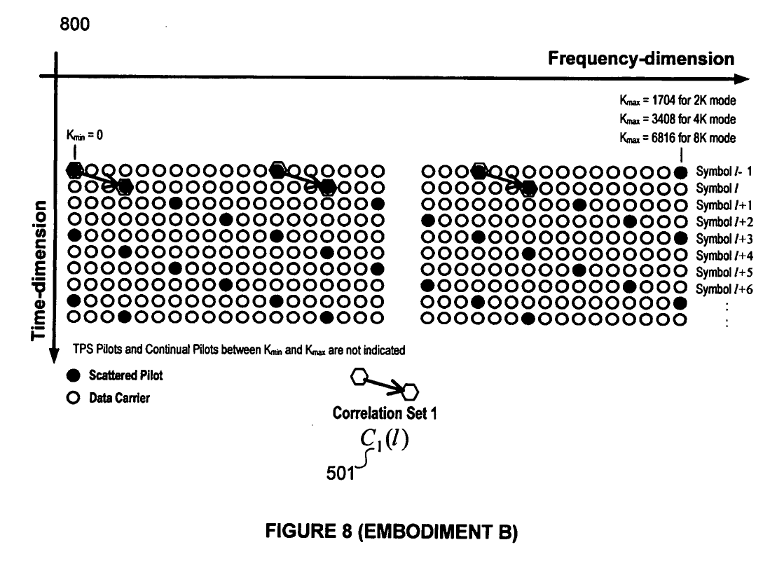

The time-frequency correlation-based scheme of the present invention can further provide a flexible design for the trade-off between hardware cost and synchronization time. Referring to FIG. 8, a diagram illustrating the SPPs for explaining another preferred embodiment in accordance with the time-frequency correlation-based scheme of the present invention. As compared with the embodiment of FIG. 5, this embodiment makes use of only one correlation set, for example, C₁(l), to determine the correct SPP of the current symbol. If the time-frequency correlation-based scheme of FIG. 8 is implemented in the same manner as FIG. 6, three set of correlators 660B, 660C and 660D can be omitted with certain modification on the SPPs identification scheme. One possible modification involved is that the judgment block 670 should include a detector provided with threshold detection approach so that the current SPPs are identified as position pattern 1 if C₁(l) is larger than a threshold value. Another possible modification is that the correlator 660A should be performed four times to obtain C₁(l), C₁(l−1), C₁(l−2) and C₁(l−3) using the (l,l−1), (l−1,l−2), (l−2,l−3) and (l−3,l−4) OFDM symbols pairs, respectively. Then, a clear distinct correlation magnitude maximum among C₁(l), C₁(l−1), C₁(l−2) and C₁(l−3) should be found by the judgement block 670. Denoting

$${l}_{max} = arg {max}_{m} ( {C}_{1} ( m ) ) ; m ∈ \{ l , l - 1 l - 2 , l - 3 \} ,$$

the SPPs of the lₘₐₓth OFDM symbol are thus identified as position pattern 1. For the same reason, any combination of two or three of the correlation sets C₁(l), C₂(l), C₃(l) and C₄(l) can be used in a similar way as a direct extension of the second embodiment shown in FIG. 8 to reduce the number of the required correlators in exchange of the increased synchronization time 2˜5 T_{OFDM}.

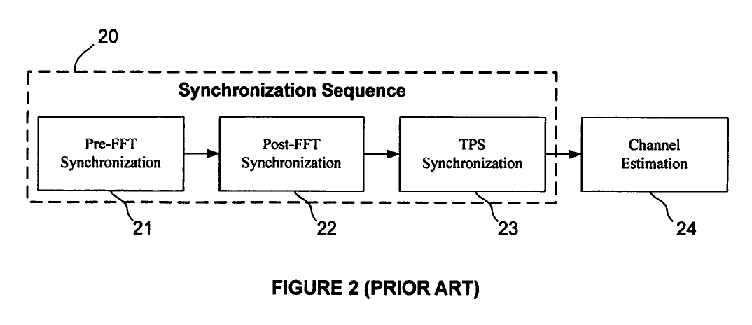

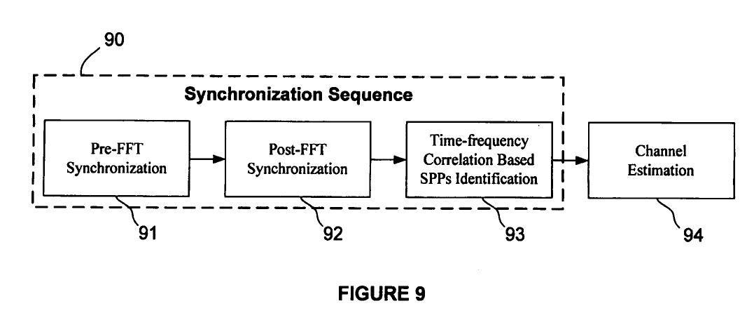

FIG. 9 is a diagram illustrating an application of the present invention in the synchronization procedure of DVB-T/H receivers. Compared to the typical DVB-T/H synchronization sequence shown in FIG. 2, SPPs required by channel estimation are identified through the present invention without TPS synchronization.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

I/We claim:

1. A method for synchronizing pilots contained in symbols received by a receiver in a multicarrier transmission system, said pilots having predetermined known values, being posited among data carriers in time and frequency dimensions consisting of said received symbols and having a predetermined position pattern in said time and frequency dimensions, wherein said predetermined position pattern comprising a finite number of sub-position patterns each corresponding to positions of pilots contained in one of said symbols, said method comprising the following steps of:
determining at least one correlation set in said time and frequency dimensions between at least two of said received symbols;
generating a correlation set result in response to each said correlation set; and
determining positions of said pilots in said time and frequency dimensions in response to said correlation set results.

2. The method of claim 1, wherein the step of determining at least one correlation set comprises the step of selecting at least one set of signal values in said time and frequency dimensions of said received symbols in response to said sub-position pattern.

3. The method of claim 1, wherein the step of generating a correlation set result further comprises the steps of:
storing a set of signal values for the previous symbol, wherein said signal values are products of signals in a set of sub-carriers multiplied by corresponding said predetermined known values of pilots, and said sub-carrier is one of said positions of pilots and said data carriers;
generating a set of signal values for the current symbol, wherein said signal values are products of signals in a set of sub-carriers multiplied by corresponding said predetermined known values of pilots, and said sub-carrier is one of said positions of pilots and said data carriers; and
generating said correlation set result by computing the absolute value of the inner product of said set of signal values for the previous symbol and said set of signal values for the current symbol in response to said determined correlation set.

4. The method of claim 1, wherein the step of generating a correlation set result further comprises the steps of:
storing a set of signal values for the previous symbol, wherein said signal values are products of signals in a set of sub-carriers multiplied by corresponding said predetermined known values of pilots, and said sub-carrier is one of said positions of pilots and said data carriers;
generating a set of signal values for the current symbol, wherein said signal values are products of signals in a set of sub-carriers multiplied by corresponding said predetermined known values of pilots, and said sub-carrier is one of said positions of pilots and said data carriers; and
generating said correlation set result by computing the absolute value of the real part of the inner product of said set of signal values for the previous symbol and said set of signal values for the current symbol in response to said determined correlation set.

5. The method of claim 1, further comprising the step of determining a maximum of said correlation set results as a plurality of said correlation set results are generated.

6. The method of claim 5, wherein the positions of said pilots of current symbol are determined as said sub-position pattern corresponding to correlation set with said maximum correlation set result.

7. The method of claim 1, further comprising:
setting a threshold value; and
determining whether said correlation set result is greater than said threshold value.

8. The method of claim 7, wherein the positions of said pilots of current symbol are determined as said sub-position pattern corresponding to correlation set with said correlation set result being greater than said threshold value.

9. An apparatus for synchronizing pilots contained in symbols received by a receiver in a multicarrier transmission system, said pilots having predetermined known values, being posited among data carriers in time and frequency dimensions consisting of said received symbols and having a predetermined position pattern in said time and frequency dimensions, wherein said predetermined position pattern comprising a finite number of sub-position patterns each corresponding to positions of pilots contained in one of said symbols such that at least one correlation set in said time and frequency dimensions between at least two of said symbols in response to said sub-position pattern can be determined, said apparatus comprising:
a pilots compensator and a signal selector for determining said at least one correlation set;
a correlator for generating one correlation set result for each said correlation set; and
a judgment unit for determining positions of said pilots in response to said correlation set result.

10. The apparatus of claim 9, wherein said pilots compensator comprises a multiplier for generating a signal value that is the product of a signal in a sub-carrier of one symbol multiplied by corresponding said predetermined known value of pilot, and said sub-carrier is one of said positions of pilots and said data carriers.

11. The apparatus of claim 9, wherein said signal selector comprises a buffer for storing a set of said signal values for the previous symbol and a set of said signal values for the current symbol.

12. The apparatus of claim 9, wherein said correlator comprises:
a complex conjugate unit for generating conjugates of said set of signal values for the previous symbol;
a complex multiplier for generating products of said conjugate of said set of signal values for the previous symbol and said set of signal values for the current symbol; and
an accumulator for generating said correlation set result by accumulating said products in response to said correlation set followed by taking the absolute value of the accumulation result.

13. The apparatus of claim 9, wherein said correlator comprises:
a real multiplier for generating real part products of real parts of said set of signal values for the previous symbol and real parts of said set of signal values for the current symbol;
a real multiplier for generating imaginary products of imaginary parts of said set of signal values for the previous symbol and imaginary parts of said set of signal values for the current symbol; and
an accumulator for generating said correlation set result by accumulating said real part products and said imaginary part products in response to said correlation set followed by taking the absolute value of the accumulation result.

14. The apparatus of claim 9, wherein said judgment unit comprises a comparator for determining a maximum of said correlation set results as a plurality of said correlation set results are generated.

15. The apparatus of claim 14, wherein the positions of said pilots of current symbol are determined by said judgment unit as said sub-position pattern corresponding to correlation set with said maximum correlation set result.

16. The apparatus of claim 9, wherein said judgment unit comprises a threshold detector for determining whether said correlation set result is greater than a predetermined threshold.

17. The apparatus of claim 16, wherein the positions of said pilots of current symbol are determined by said judgment unit as said sub-position pattern corresponding to correlation set with said correlation set result being greater than said predetermined threshold.
